(19) United States
(12) Patent Application Publication
(10) Pub. No.: US 2017/0260368 A1
(43) Pub. Date: Sep. 14, 2017

(54) Methyl and Octyl Tin - REACH Compliant High Performance Stabilizer for PVC Film Manufacture

(71) Applicant: PMC Organometallix, Inc., Mt. Laurel, NJ (US)

(72) Inventors: Keith Mesch, Mt. Laurel, NJ (US); Anthony Dymek, Mt. Laurel, NJ (US)

(73) Assignee: PMC Organometallix, Inc., Mt. Laurel, NJ (US)

(21) Appl. No.: 15/419,881

(22) Filed: Jan. 30, 2017

Related U.S. Application Data
(60) Provisional application No. 62/305,013, filed on Mar. 8, 2016.

(51) Int. Cl. C08K 5/58

(52) U.S. Cl. CPC C08K 5/58; C08K 2201/014

(57) ABSTRACT

A liquid organotin heat stabilizer for clear, opaque and/or colored calendered rigid Polyvinyl Chloride (PVC) comprising octyltin mercaptide and methyltin mercaptide. Octyltin mercaptide is used to develop good early color in a clear, opaque or colored calendered rigid PVC film application. Methyltin mercaptide is used to improve the long term heat stability (reduced burning) of the clear, opaque or colored rigid calendered PVC films. Ranges from 50% to 75% octyltin mercaptide, and from 50% to 25% methyltin mercaptide have application. Preferred ranges are 60% to 64% octyltin mercaptide and 40% to 36% methyltin mercaptide. Most preferred is 62% octyltin mercaptide and 38% methyltin mercaptide.

### CROSS-REFERENCE TO RELATED APPLICATIONS

This application claims the benefit of U.S. Provisional Patent Application Ser. No. 62/305,013, filed 8 Mar. 2016. Priority of U.S. Provisional Patent Application Ser. No. 62/305,013, filed 8 Mar. 2016, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### FIELD OF THE INVENTION

The present invention relates to liquid organotin heat stabilizers for clear, opaque and colored calendered rigid Polyvinyl Chloride (PVC); and particularly a blended discrete organotin stabilizer comprising octyltin mercaptide and methyltin mercaptide.

### BACKGROUND OF THE INVENTION

The idea of blending two discrete organotin stabilizers together is a new approach to solving two issues: the first is improved performance being good early color and improved long term heat stability. The second is conformance with REACH legislation so PVC based finished products can avoid being labeled as a “Substance of Very High Concern” due to the organotin tin stabilizer. High mono octyl tin stabilizers are fully compliant with the REACH legislation as well as high Di Methyl organotin stabilizers.

REACH: Registration, Evaluation, Authorisation and Restriction of Chemicals, is a European Union regulation dated 18 Dec. 2006. REACH addresses the production and use of chemical substances, and their potential impacts on both human health and the environment.

The concept of using organotin stabilizers in rigid PVC as a heat stabilizer has been in practice since the 1950's. Organotin heat stabilizers are the only heat stabilizer used for rigid PVC that will allow the manufacture to produce a clear film. Other stabilizers cannot be used since their refractive index does not match that of the PVC which does not allow for a clear PVC film.

Octyltin mercaptide is used to develop good early color in a clear, opaque or colored calendered rigid PVC film application. Methyltin mercaptide is used to improve long term heat stability (reduced burning) of the clear, opaque or colored rigid calendered PVC films. Methyltin mercaptide, therefore, allows for long term color hold during processing of the rigid PVC film. The methyltin mercaptide also has low volatility (less fumes during processing) which is important during manufacturing of the rigid PVC films.

Rigid PVC film is processed at a temperature in excess of 400° F., a temperature at which PVC becomes unstable and quickly bums without the use of a heat stabilizer. As noted, both methyltin mercaptide and octyltin mercaptide function as a heat stabilizer in rigid PVC. However neither product on its own will achieve desired properties in finished goods. What is needed is a new stabilizer capable of achieving these desired properties.

### SUMMARY OF THE INVENTION

The present invention provides a liquid organotin heat stabilizer for clear, opaque and/or colored calendered rigid Polyvinyl Chloride (PVC). The organotin stabilizer of the present invention prevents the PVC from degrading and turning color during processing of the calendered film. The stabilizer imparts clarity to clear films as well as color hold to colored films.

Since PVC is a chlorine-based plastic it is inherently unstable during processing. The organotin stabilizer of the present invention prevents the PVC from crosslinking and burning during processing. The stabilizer prevents the formation of HC1 (hydrochloric acid) to form by replacing this defect site with a functionality from the tin molecule.

The present invention includes various embodiments. In one embodiment, a composition is provided comprising: from 40 wt % to 75 wt % octyltin mercaptide; and from 60 wt % to 25 wt % methyltin mercaptide. In this embodiment, the octyltin mercaptide includes 90 wt % to 98 wt % Octyltin tris(2-ethylhexyl mercaptoacetate) and 10 wt % to 2 wt % Dioctyltin bis(2-ethylhexyl mercaptoacetate); and the methyltin mercaptide includes 76 wt % to 71 wt % Dimethyltin bis(2-ethylhexyl mercaptoacetate) and 24 wt % to 29 wt % Methyltin tris(2-ethylhexyl mercaptoacetate). In a preferred embodiment, the octyltin mercaptide includes 95 wt % Octyltin tris(2-ethylhexyl mercaptoacetate) and 5 wt % Dioctyltin bis(2-ethylhexyl mercaptoacetate); and the methyltin mercaptide includes 74 wt % Dimethyltin bis(2-ethylhexyl mercaptoacetate) and 26 wt % Methyltin tris(2-ethylhexyl mercaptoacetate).

In other aspects of the invention, the weight ratio of octyltin mercaptide to methyltin mercaptide is not less than 60/40. Preferably, the weight ratio of octyltin mercaptide can be 60 wt % to 64 wt %, and methyltin mercaptide can be 40 wt % to 36 wt %.

More preferably, the weight ratio of octyltin mercaptide to methyltin mercaptide is 62/38. In this embodiment, the octyltin mercaptide contains mono octyl tin and di octyl tin mercaptide, and comprises 14 wt % tin, the methyltin mercaptide contains mono methyl tin and di methyl tin, and comprises 19% tin.

In another aspect of the invention, the weight ratio of octyltin mercaptide to methyltin mercaptide is not less than 75/25.

The organotin stabilizers of the present invention are included in articles of polyvinyl chloride, where 3 wt % to 0.5 wt % of the article is the stabilizer of the present invention.

### BRIEF DESCRIPTION OF THE ILLUSTRATED EMBODIMENTS

The present invention will be better understood with reference to the following description taken in combination with the drawings. For the purpose of illustration, there are shown in the drawings certain embodiments of the present invention. In the drawings, like numerals indicate like elements throughout. It should be understood, however, that the invention is not limited to the precise arrangements, dimensions, and instruments shown:

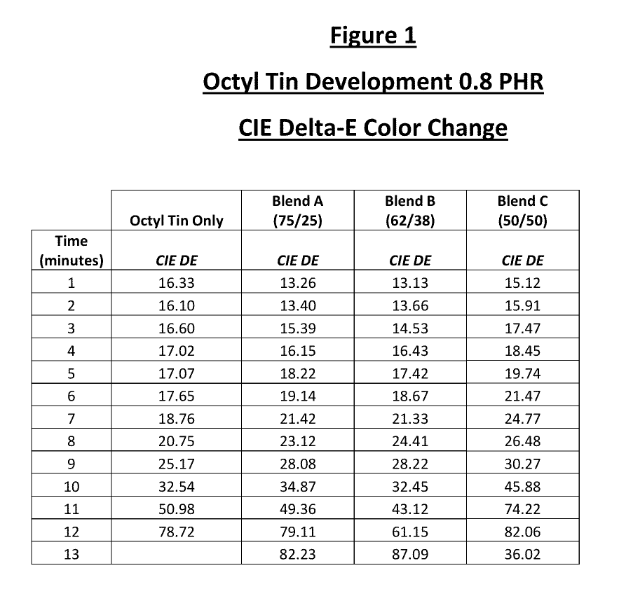

FIG. 1 shows Octyl Tin Development 0.8 PHR, CIE Delta-E Color Change;

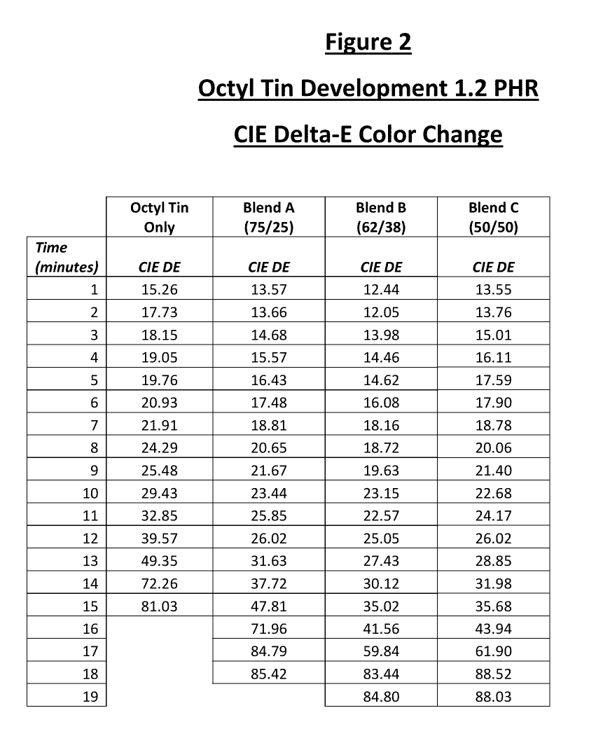

FIG. 2 shows Octyl Tin Development 1.2 PHR, CIE Delta-E Color Change;

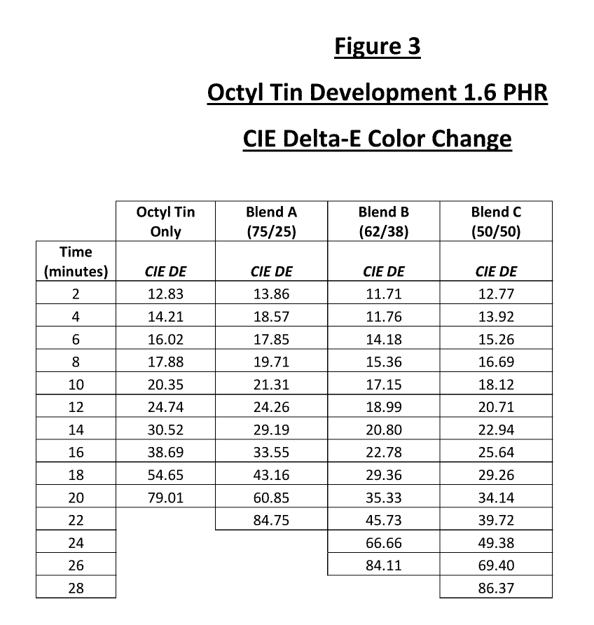

FIG. 3 shows Octyl Tin Development 1.6 PHR, CIE Delta-E Color Change;

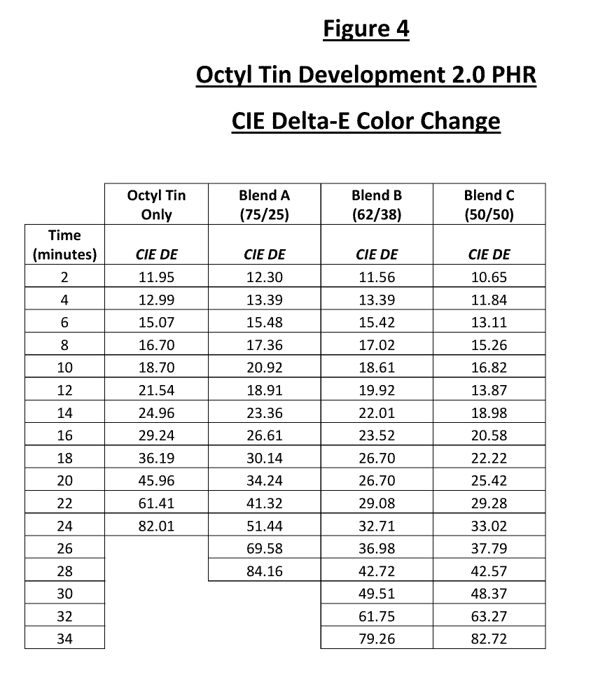

FIG. 4 shows Octyl Tin Development 2.0 PHR, CIE Delta-E Color Change.

### DETAILED DESCRIPTION OF THE ILLUSTRATED EMBODIMENTS

The present invention contains a blend of two discrete organotin stabilizers: octyltin mercaptide and methyltin mercaptide. Octyltin mercaptide is used to develop good early color in a clear, opaque or colored calendered rigid PVC film application. Methyltin mercaptide is used to improve the long term heat stability (reduced burning) of the clear, opaque or colored rigid calendered PVC films. The methyltin mercaptide also has low volatility (less fumes during processing) which is important during manufacturing of the rigid PVC films. The two discrete organotin stabilizers are blended together to form one homogeneous organotin stabilizer.

Blending two discrete organotin stabilizers is a new approach to solving two issues. The first is improved performance being good early color and improved long term heat stability. The second is conformance to REACH legislation; providing that PVC-based finished products can avoid being labeled “Substance of Very High Concern,” due to the organotin tin stabilizer. High mono octyl tin stabilizers are fully compliant with REACH legislation as well as high Di Methyl organotin stabilizers.

The octyltin mercaptide and methyltin mercaptide blend of the present invention, provides an optimum level of overall term heat stability and color hold in calendering operations. The octyltin or methyltin, alone, does not provide the same performance as the combination. Performance results of the blend of the present invention is much better than that expected (or otherwise would be predicted) by an averaging of the performance of the octyltin mercaptide or the methyltin mercaptide components alone. Other, additional benefits not expected (or otherwise foreseen) include improved lubricity and lower volatility.

The specific blend of octyltin mercaptide and methyltin mercaptide is important. If the octyltin mercaptide were removed from the stabilizer, the good early color of the finished rigid PVC film would deteriorate, possibly to a point where the finished part would not be usable due to the importance of good early color and clarity. If the methyltin mercaptide were removed from the stabilizer, long term heat stability could suffer, leading to material burning on processing equipment due to processing temperatures in excess of 400° F.

Accordingly, depending on processing requirements, neither the octyltin mercpatide nor the methyltin mercaptide can be desirably replaced due to the specific function each performs: good early color (octyltin mercaptide) and long term heat stability (methyltin mercaptide). Being an organotin heat stabilizer, the blend of the present invention can be used in any rigid PVC application requiring a heat stabilizer. The organotin stabilizer of the present invention, however, is preferably directed to clear, opaque and colored rigid PVC films. While plastic could be used in place of PVC, most plastics do not need a heat stabilizer for processing. Only PVC requires a heat stabilizer for processing; therefore, PVC is preferable in any application. In a PVC article, the stabilizer composition of the present invention comprises 3% to 0.5% of the PVC article.

In one embodiment, a stabilizer composition of the present invention comprises 40% to 75% octyltin mercaptide and 60% to 25% methyltin mercaptide. A stabilizer blend of this range has application depending on processing requirements.

In a preferred embodiment, the stabilizer composition comprises 60% to 64% octyltin mercaptide and 40% to 36% methyltin mercaptide. In a more preferred embodiment, the stabilizer composition comprises 62% octyltin mercaptide and 38% methyltin mercaptide.

In the above embodiments, the octyltin mercaptide includes 90% to 98% Octyltin tris(2-ethylhexyl mercaptoacetate) and 10% to 2% Dioctyltin bis(2-ethylhexyl mercaptoacetate). The methyltin mercaptide includes 76% to 71% Dimethyltin bis(2-ethylhexyl mercaptoacetate) and 24% to 29% Methyltin tris(2-ethylhexyl mercaptoacetate). In a preferred embodiment, the octyltin mercaptide includes 95 wt % Octyltin tris(2-ethylhexyl mercaptoacetate) and 5 wt % Dioctyltin bis(2-ethylhexyl mercaptoacetate); and the methyltin mercaptide includes 74 wt % Dimethyltin bis(2-ethylhexyl mercaptoacetate) and 26 wt % Methyltin tris(2-ethylhexyl mercaptoacetate). The resulting stabilizer composition is 14% tin and is an Octyl Tin stabilizer containing Mono Octyl tin and Di Octyl tin mercaptide and Methyl Tin mercaptide stabilizer containing 19% tin with Mono methyl tin and Di Methyl tin.

One embodiment of the present invention includes a stabilizer of 50% octyltin mercaptide and 50% methyltin mercaptide (50/50) blend. Another embodiment includes a stabilizer of 70% octyltin mercaptide and 30% methyltin mercaptide (70/30) blend. In each of the 50/50 and 70/30 stabilizer blends, the portion of octyltin mercaptide includes 90% to 98% Octyltin tris(2-ethylhexyl mercaptoacetate) and 10% to 2% Dioctyltin bis(2-ethylhexyl mercaptoacetate); and the portion of methyltin mercaptide includes 76% to 71% Dimethyltin bis(2-ethylhexyl mercaptoacetate) and 24% to 29% Methyltin tris(2-ethylhexyl mercaptoacetate). In some experiments, the 70/30 blend provided a better level of overall term heat stability and color hold.

FIG. 1 shows a table, showing color over time (in minutes) for PVC articles processed at 390° F. and 0.8 PHR (stabilizer parts per hundred resin). Or, 0.8% stabilizer in the PVC article. From left to right, FIG. 1 illustrates a Control stabilizer (of octyltin mercaptide only); a Blend A stabilizer (of 75% octyltin mercaptide and 25% methyltin mercaptide—(75/25) blend), in accordance with one embodiment of the present invention; a Blend B stabilizer (of 62% octyltin mercaptide and 38% methyltin mercaptide—(62/38) blend), in accordance with another embodiment of the present invention; and finally a Blend C stabilizer of 50% octyltin mercaptide and 50% methyltin mercaptide—(50/50) blend, in accordance with still another embodiment of the present invention. In each of stabilizer Blend A (75/25), Blend B (62/38), and Blend C (50/50), the portion of octyltin mercaptide includes 90% to 98% Octyltin tris(2-ethylhexyl mercaptoacetate) and 10% to 2% Dioctyltin bis(2-ethylhexyl mercaptoacetate); and the portion of methyltin mercaptide includes 76% to 71% Dimethyltin bis(2-ethylhexyl mercaptoacetate) and 24% to 29% Methyltin tris(2-ethylhexyl mercaptoacetate). FIG. 1 illustrates a color rating (thereby providing a change in color (E) over time in minutes) for PVC product chips for each of the PVC articles having the Control, the Blend A, the Blend B, and the Blend C stabilizers at PHR 0.8. The table illustrates that, of the PVC article examples included therein, Blend B (the 62/38 blend) provides the best level of overall term heat stability and color hold.

FIG. 2 is a table showing color over time (in minutes) for PVC articles processed at 390° F. and 1.2 PHR (stabilizer parts per hundred resin). Or, 1.2% stabilizer in the PVC article. From left to right, FIG. 2 illustrates a Control stabilizer (of octyltin mercaptide only); a Blend A stabilizer (of 75% octyltin mercaptide and 25% methyltin mercaptide—(75/25) blend), in accordance with one embodiment of the present invention; a Blend B stabilizer (of 62% octyltin mercaptide and 38% methyltin mercaptide—(62/38) blend), in accordance with another embodiment of the present invention; and finally a Blend C stabilizer of 50% octyltin mercaptide and 50% methyltin mercaptide—(50/50) blend, in accordance with still another embodiment of the present invention. In each of stabilizer Blend A (75/25), Blend B (62/38), and Blend C (50/50), the portion of octyltin mercaptide includes 90% to 98% Octyltin tris(2-ethylhexyl mercaptoacetate) and 10% to 2% Dioctyltin bis(2-ethylhexyl mercaptoacetate); and the portion of methyltin mercaptide includes 76% to 71% Dimethyltin bis(2-ethylhexyl mercaptoacetate) and 24% to 29% Methyltin tris(2-ethylhexyl mercaptoacetate). The table shows a color rating (thereby providing a change in color (E) over time in minutes) for PVC product chips having the Control, the Blend A, the Blend B, and the Blend C stabilizers at PHR 1.2. FIG. 2 illustrates that, of the PVC article examples included therein, Blend B (the 62/38 blend) provides the best level of overall term heat stability and color hold.

FIG. 3 is a table showing color over time (in minutes) for PVC articles processed at 390° F. and 1.6 PHR (stabilizer parts per hundred resin). Or, 1.6% stabilizer in the PVC article. From left to right, FIG. 3 illustrates a Control stabilizer (of octyltin mercaptide only); a Blend A stabilizer (of 75% octyltin mercaptide and 25% methyltin mercaptide—(75/25) blend), in accordance with one embodiment of the present invention; a Blend B stabilizer (of 62% octyltin mercaptide and 38% methyltin mercaptide—(62/38) blend), in accordance with another embodiment of the present invention; and finally a Blend C stabilizer of 50% octyltin mercaptide and 50% methyltin mercaptide—(50/50) blend, in accordance with still another embodiment of the present invention. In each of stabilizer Blend A (75/25), Blend B (62/38), and Blend C (50/50), the portion of octyltin mercaptide includes 90% to 98% Octyltin tris(2-ethylhexyl mercaptoacetate) and 10% to 2% Dioctyltin bis(2-ethylhexyl mercaptoacetate); and the portion of methyltin mercaptide includes 76% to 71% Dimethyltin bis(2-ethylhexyl mercaptoacetate) and 24% to 29% Methyltin tris(2-ethylhexyl mercaptoacetate). The table gives a color rating (thereby providing a change in color (E) over time in minutes) for PVC product chips having the Control, the Blend A, the Blend B, and the Blend C stabilizers at PHR 1.6. FIG. 3 illustrates that, of the PVC article examples included therein, Blend C (the 50/50 blend), followed by Blend B (the 62/38 blend) provides the best level of overall term heat stability and color hold.

FIG. 4 is a table showing color over time (in minutes) for PVC articles processed at 390° F. and 2.0 PHR (stabilizer parts per hundred resin). Or, 2.0% stabilizer in the PVC article. From left to right, FIG. 4 illustrates a Control stabilizer (of octyltin mercaptide only); a Blend A stabilizer (of 75% octyltin mercaptide and 25% methyltin mercaptide—(75/25) blend), in accordance with one embodiment of the present invention; a Blend B stabilizer (of 62% octyltin mercaptide and 38% methyltin mercaptide—(62/38) blend), in accordance with another embodiment of the present invention; and finally a Blend C stabilizer of 50% octyltin mercaptide and 50% methyltin mercaptide—(50/50) blend, in accordance with still another embodiment of the present invention. In each of stabilizer Blend A (75/25), Blend B (62/38), and Blend C (50/50), the portion of octyltin mercaptide includes 90% to 98% Octyltin tris(2-ethylhexyl mercaptoacetate) and 10% to 2% Dioctyltin bis(2-ethylhexyl mercaptoacetate); and the portion of methyltin mercaptide includes 76% to 71% Dimethyltin bis(2-ethylhexyl mercaptoacetate) and 24% to 29% Methyltin tris(2-ethylhexyl mercaptoacetate). The table gives a color rating (thereby providing a change in color (E) over time in minutes) for PVC product chips having the Control, the Blend A, the Blend B, and the Blend C stabilizers at PHR 2.0. FIG. 4 illustrates that, of the PVC article examples included therein, Blend B (the 62/38 blend), followed by Blend C (the 50/50 blend), provides the best level of overall term heat stability and color hold.

Various changes and modifications in the above described stabilizer blend will be apparent to those of ordinary skill in this art. The embodiments specifically described above were for illustration purposes and were not intended to be limiting. These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. For example, features detailed as included in certain specific embodiments above are recognized as interchangeable and possibly included in other detailed embodiments. Specific dimensions of any particular embodiment are described for illustration purposes only. It should therefore be understood that this invention is not limited to the particular embodiments described herein, but is intended to include all changes and modifications that are within the scope and spirit of the invention.

1. A composition comprising:
from 40 wt % to 75 wt % octyltin mercaptide; and from 60 wt % to 25 wt % methyltin mercaptide.
wherein:
the octyltin mercaptide includes 90 wt % to 98 wt % Octyltin tris(mercaptide) and 10 wt % to 2 wt % Dioctyltin bis(mercaptide); and
the methyltin mercaptide includes 81 wt % to 71 wt % Dimethyltin bis(mercaptide) and 19 wt % to 29 wt % Methyltin tris(mercaptide).

2. The composition of claim 1 wherein the mercaptide is selected from one or more of the following: alkylmercaptoacetate, mercaptoetheyl carboxylate, and/or alkylmercaptide.

3. A composition comprising:
from 40 wt % to 75 wt % octyltin mercaptide; and from 60 wt % to 25 wt % methyltin mercaptide.
wherein:
the octyltin mercaptide includes 90 wt % to 98 wt % Octyltin tris(mercaptide) and 10 wt % to 2 wt % Dioctyltin bis(mercaptide); and
the methyltin mercaptide includes 81 wt % to 71 wt % Dimethyltin bis(mercaptide) and 19 wt % to 29 wt % Methyltin tris(mercaptide).

4. The composition of claim 3 wherein the mercaptide is 2-ethylhexylmercaptoacetate.

5. The composition of claim 3 wherein:
the octyltin mercaptide includes 95 wt % Octyltin tris(2-ethylhexyl mercaptoacetate) and 5 wt % Dioctyltin bis(2-ethylhexyl mercaptoacetate); and
the methyltin mercaptide includes 74 wt % Dimethyltin bis(2-ethylhexyl mercaptoacetate) and 26 wt % Methyltin tris(2-ethylhexyl mercaptoacetate).

6. The composition of claim 3 wherein the weight ratio of octyltin mercaptide to methyltin mercaptide is not less than 50/50.

7. The composition of claim 3, wherein the weight ratio of octyltin mercaptide to methyltin mercaptide is not less than 60/40.

8. The composition of claim 7, wherein the weight ratio of octyltin mercaptide is 60 wt % to 64 wt %, and methyltin mercaptide is 40 wt % to 36 wt %.

9. The composition of claim 7, wherein the weight ratio of octyltin mercaptide to methyltin mercaptide is 62/38.

10. The composition of claim 9, wherein:
the octyltin mercaptide includes 95 wt % Octyltin tris(2-ethylhexyl mercaptoacetate) and 5 wt % Dioctyltin bis(2-ethylhexyl mercaptoacetate); and
the methyltin mercaptide includes 74 wt % Dimethyltin bis(2-ethylhexyl mercaptoacetate) and 26 wt % Methyltin tris(2-ethylhexyl mercaptoacetate).

11. The composition of claim 9, wherein the octyltin mercaptide contains mono octyl tin and di octyl tin mercaptide, and comprises 14 wt % tin, the methyltin mercaptide contains mono methyl tin and di methyl tin, and comprises 19% tin.

12. The composition of claim 3, wherein the weight ratio of octyltin mercaptide to methyltin mercaptide is not less than 75/25.

13. An article comprising polyvinyl chloride, wherein 3 wt % to 0.5 wt % of the article is the composition of claim 3, 5, 6, 9 or 11.

14. (canceled) Page 3 of 5
